(19) United States
(12) Patent Application Publication
(10) Pub. No.: US 2026/0126333 A1
(43) Pub. Date: May 7, 2026

(54) Pressure Sensor and Pressure Interface Thereof

(71) Applicant: Measurement Specialties (China) Ltd., Shenzhen City (CN)

(72) Inventors: Pengcheng Feng, Shenzhen (CN); Jianhai (Ross) Qiu, Shenzhen (CN); Xuetang Zhao, Shenzhen (CN)

(73) Assignee: Measurement Specialties (China) Ltd., Shenzhen City (CN)

(21) Appl. No.: 19/378,891

(22) Filed: Nov. 4, 2025

(30) Foreign Application Priority Data
Nov. 4, 2024 (CN) 202411563368.9

(51) Int. Cl. G01L 19/14; G01L 9/04

(52) U.S. Cl. CPC G01L 19/141; G01L 9/04

(57) ABSTRACT

A pressure sensor includes a pressure interface and a strain gauge. The pressure interface includes a cylindrical ceramic base and a ceramic diaphragm provided at one end of the ceramic base. The strain gauge is connected to the ceramic diaphragm. The ceramic base and the ceramic diaphragm are integrally formed.

### CROSS-REFERENCE TO RELATED APPLICATION

This application claims the benefit of the filing date under 35 U.S.C. § 119(a)-(d) of Chinese Application No. 202411563368.9, filed on Nov. 4, 2024.

### FIELD OF THE INVENTION

Embodiments of the present disclosure relate to a pressure sensor and a pressure interface of the pressure sensor.

### BACKGROUND OF THE INVENTION

Pressure sensors are one of the most widely used sensors in industrial applications, and are extensively applied in water conservancy, hydropower, railway transportation, intelligent buildings, petrochemical industries, and so on. Currently, the pressure sensors typically comprise a pressure interface and a strain gauge, in which the strain gauge is adhered to a diaphragm of the pressure interface via glass, which is melted using high-temperature micro-melting technology. When external pressure acts on the sensor, the diaphragm undergoes slight deformation, which subsequently causes changes in a resistance of the strain gauge. However, the existing diaphragms are usually made of stainless steel, having the following drawbacks: (1) significant difference in thermal expansion coefficients between glass and stainless steel diaphragm leads to poor thermal stability of the resistance of the strain gauge; (2) the typical thickness of the glass under 0.1 mm results in low insulation and dielectric strengths between the strain gauge and the stainless steel diaphragm, making it difficult for the sensors to obtain enhanced safety certification; and (3) the stainless steel diaphragm requires complex pretreatment processes including heat treatment, sandblasting, ultrasonic cleaning and so on; (4) the stainless steel pressure interfaces are typically machined by computer numerical control (CNC), resulting in high costs and relatively low burst pressure and overpressure.

### SUMMARY OF THE INVENTION

A pressure sensor includes a pressure interface having a ceramic base and a ceramic diaphragm disposed at an end of the ceramic base. The ceramic base and the ceramic diaphragm are integrally formed. The pressure sensor includes a strain gauge connected to the ceramic diaphragm.

### BRIEF DESCRIPTION OF THE DRAWINGS

The invention will now be described by way of example with reference to the accompanying figures, of which:

FIG. 1 is a schematic perspective view of a structure of a pressure sensor according to a first exemplary embodiment of the present disclosure;

FIG. 2 is a cross-sectional view of the pressure sensor shown in FIG. 1;

FIG. 3 is a schematic perspective view of a structure of a pressure sensor according to a second exemplary embodiment of the present disclosure; and

FIG. 4 is a part cross-sectional view of the pressure sensor shown in FIG. 3.

### DETAILED DESCRIPTION

Although the present disclosure will be fully described with reference to the drawings containing embodiments of the present disclosure, it should be understood that those skilled in the art may modify the present disclosure described herein and obtain the technical effect of the present disclosure. Therefore, it is necessary to understand that the above description is a broad disclosure for those skilled in the art and is not intended to limit the exemplary embodiments described in the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

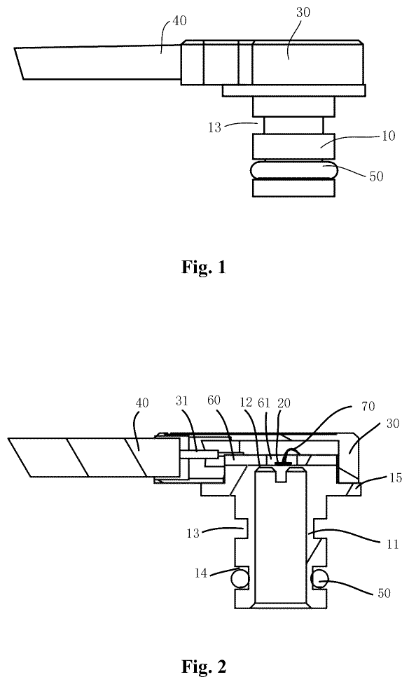

As shown in FIG. 1 and FIG. 2, according to a first exemplary embodiment of the present disclosure, the pressure sensor includes a pressure interface 10 and a strain gauge 20. The pressure interface 10 includes a ceramic base 11 that is substantially cylindrical and a ceramic diaphragm 12 provided at one end of the ceramic base 11. The strain gauge 20 is connected to the ceramic diaphragm 12, so that when the pressure medium to be measured (e.g., gas or liquid) enters a cavity of the ceramic base 11 through an opening end of the ceramic diaphragm 12, the ceramic diaphragm 12 will deform, and the magnitude of this deformation is proportional to the pressure of the pressure medium to be measured.

When the ceramic diaphragm 12 deforms, the ceramic diaphragm 12 drives the strain gauge 20 to deform, and the strain gauge 20 deforms along with the deformation of the ceramic diaphragm 12, which further causes a change in the resistance of the strain gauge 20. By testing the change in the resistance of the strain gauge 20, the pressure of the medium to be measured can be obtained.

In this embodiment, the ceramic base 11 and the ceramic diaphragm 12 of the pressure interface 10 are integrally formed, for example by sintering in a mold. Since the ceramic base 11 and the ceramic diaphragm 12 of the pressure interface 10 are integrally formed, there is no need for additional assembly and sealing, and there is no risk of leakage, while the cost is low. Further, since the pressure sensor is made of ceramic material which is used to be in contact with the pressure medium in use, it can be applied to corrosive pressure medium and dialysis, etc. Furthermore, the surface roughness and cleanliness of the pressure interface 10 achieved by sintering meet all requirements, eliminating the need for sandblasting, cleaning processes, or heat treatment. In addition, the extremely low electrical conductivity of the ceramic material resolves the issues of insufficient insulation and dielectric strengths between the strain gauge 20 and the ceramic diaphragm 12.

According to an exemplary embodiment of the present disclosure, as shown in FIG. 2, the strain gauge 20 is adhered to the ceramic diaphragm 12 via glass which is melted by a glass micro-melting process. Due to the small difference in the coefficients of thermal expansion between the glass and the ceramics, when the temperature changes, the strain influence on the strain gauge 20 is relatively small, resulting in high thermal stability. Therefore, the measurement accuracy of this pressure sensor can be improved.

According to an exemplary embodiment of the present disclosure, as shown in FIG. 2, the strain gauge 20 is made of a semiconductor material. This can enhance the sensitivity of the pressure sensor, for instance, it can reach over 20 mV/V, and the subsequent signal processing will be simpler and more accurate. It should be noted that in some other embodiments of the present disclosure, the strain gauge 20 can also be made of other materials, such as a ceramic material, etc.

According to an exemplary embodiment of the present disclosure, as shown in FIG. 1 and FIG. 2, the pressure sensor further includes a cap 30 covering the pressure interface 10. Specifically, in this embodiment, the ceramic base 11 is formed with a flange 15 extending radially outward, and the cap 30 is adhered to the flange 15. It should be noted that in some other embodiments not shown in the present disclosure, the cap 30 can also be installed on the pressure interface 10 by other connections, such as snap-fit connection, bolt connection, etc.

According to an exemplary embodiment of the present disclosure, as shown in FIG. 2, the pressure sensor further includes a circuit board 60 located on the ceramic diaphragm 12, wherein the circuit board 60 is electrically connected to the strain gauge 20 via a bond wire 70, in order to process the resistance change signal of the strain gauge 20. This circuit board 60, for example, can be a flexible circuit board or a rigid circuit board. Specifically, in this embodiment, the circuit board 60 has a through hole 61 at its center, and the strain gauge 20 is adhered onto the ceramic diaphragm 12 at the position corresponding to the through hole 61, which can provide certain protection for the strain gauge 20.

According to an exemplary embodiment of the present disclosure, as shown in FIG. 1 and FIG. 2, a cable 40 connected to the circuit board 60 is adhered to the circuit board 60 and is led out through a wire passing hole 31 provided in the cap 30.

According to an exemplary embodiment of the present disclosure, as shown in FIG. 2, a side wall of the ceramic base 11 is formed with a groove 14, and a sealing ring 50 is provided in the groove 14, in order to prevent the leakage of the pressure medium to be measured, thereby enhancing the sealing effect.

According to an exemplary embodiment of the present disclosure, as shown in FIG. 2, an outer side wall of the ceramic base 11 is formed with an installation groove 13 by which the pressure sensor is installed on a component to be measured. For example, it can be installed by passing two pins through the installation groove 13 of the pressure interface 10.

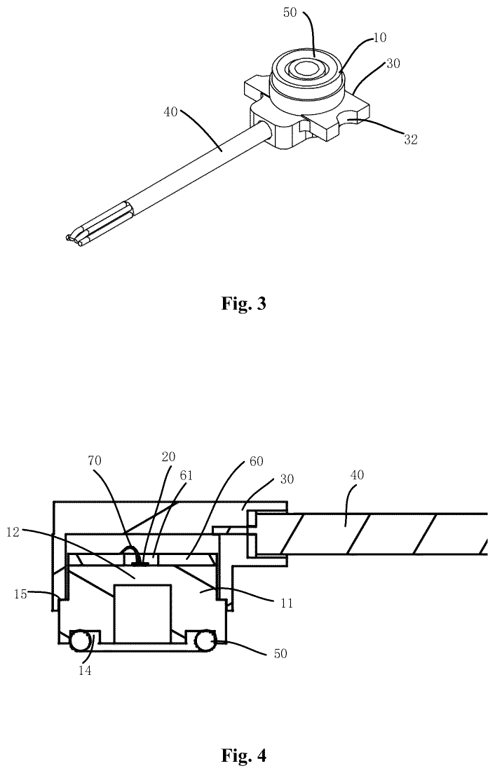

FIG. 3 is a schematic perspective view of a structure of a pressure sensor according to a second exemplary embodiment of the present disclosure; and FIG. 4 is a part cross-sectional view of the pressure sensor shown in FIG. 3. The difference between the pressure sensor according to the second embodiment of the present disclosure and that according to the first embodiment of the present disclosure lies in the installation positions of the cap and the sealing ring of the pressure sensor.

As shown in FIG. 3 and FIG. 4, a groove 14 is formed in an end face of the ceramic base 11 at the end away from the ceramic diaphragm 12, and a sealing ring 50 is provided in the groove 14, to prevent the leakage of the pressure medium to be measured, thereby enhancing the sealing effect of this pressure sensor.

As shown in FIG. 3 and FIG. 4, the cap 30 is formed with an installation recess 32, which is used to replace the installation groove 13 of the ceramic base 11 of the pressure interface according to the first embodiment of the present disclosure. In this embodiment, the pressure sensor is installed on a component to be measured by the installation recess 32 of the cap 30.

According to another aspect of the present disclosure, there is provided a pressure interface 10 for a pressure sensor, and the pressure interface 10 may adopt the one as described above. Specifically, the pressure interface 10 includes a ceramic base 11 that is substantially cylindrical and a ceramic diaphragm 12 provided at one end of the ceramic base 11. The ceramic base 11 and the ceramic diaphragm 12 of the pressure interface 10 are integrally formed, for example by sintering in a mold. Since the ceramic base 11 and the ceramic diaphragm 12 of the pressure interface 10 are integrally formed, there is no need for additional assembly and sealing, and there is no risk of leakage, while the cost is low. Further, since the pressure sensor is made of a ceramic material which is used to be in contact with pressure medium in use, it can be applied to corrosive pressure media and dialysis, etc.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate embodiments of the present disclosure by way of example, and should not be construed as limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “comprise” or “include” doesn't exclude other elements or steps, and the word “a” or “an” doesn't exclude more than a plurality. In addition, any reference numerals in the claims should not be interpreted as the limitation to the scope of the present disclosure.

1. A pressure sensor, comprising:
a pressure interface including a ceramic base and a ceramic diaphragm disposed at an end of the ceramic base, the ceramic base and the ceramic diaphragm are integrally formed; and
a strain gauge connected to the ceramic diaphragm.

2. The pressure sensor of claim 1, wherein the ceramic base is cylindrical.

3. The pressure sensor of claim 1, wherein the strain gauge is adhered to the ceramic diagram via a glass.

4. The pressure sensor of claim 3, wherein the glass is melted by a glass micro-melting process.

5. The pressure sensor of claim 1, wherein the strain gauge is made of a semiconductor material.

6. The pressure sensor of claim 1, further comprising a cap covering an end of the pressure interface having the ceramic diaphragm.

7. The pressure sensor of claim 6, wherein the ceramic base has a flange extending radially outward.

8. The pressure sensor of claim 7, wherein the cap is adhered to the flange.

9. The pressure sensor of claim 6, further comprising a circuit board on the ceramic diaphragm.

10. The pressure sensor of claim 9, wherein the circuit board is electrically connected to the strain gauge via a bond wire.

11. The pressure sensor of claim 10, wherein a cable connected to the circuit board is adhered to the circuit board.

12. The pressure sensor of claim 11, wherein the cable extends through a wire passing hole in the cap.

13. The pressure sensor of claim 6, wherein a side wall of the ceramic base has a groove, and further comprising a sealing ring disposed in the groove.

14. The pressure sensor of claim 13, wherein the groove is in an end face of the ceramic base opposite the ceramic diaphragm.

15. The pressure sensor of claim 1, wherein the ceramic base has a installation groove by which the pressure sensor is installed on a component to be measured.

16. The pressure sensor of claim 6, wherein the cap has an installation recess by which the pressure sensor is installed on a component to be measured.

17. A pressure interface for a pressure sensor, the pressure interface comprising:
a ceramic base; and
a ceramic diaphragm disposed at an end of the ceramic base, the ceramic base and the ceramic diaphragm are integrally formed.

18. The pressure interface of claim 17, wherein the ceramic base is cylindrical.
